(19) United States
(12) Patent Application Publication
(10) Pub. No.: US 2026/0194676 A1
(43) Pub. Date: Jul. 9, 2026

(54) System and Method for Three-Dimensional Efficient Data-Driven Internal Multiple Elimination for Wide Azimuth Dataset

(71) Applicant: Saudi Arabian Oil Company, Dhahran (SA)

(72) Inventors: Dongliang Zhang, Khobar (SA); Constantinos Tsingas, Dhahran (SA); Mohammed Mubarak, Dhahran (SA)

(73) Assignee: Saudi Arabian Oil Company, Dhahran (SA)

(21) Appl. No.: 19/010,927

(22) Filed: Jan. 6, 2025

(51) Int. Cl. G01V 1/36; G01V 1/34

(52) U.S. Cl. CPC G01V 1/362; G01V 1/345; G01V 2210/165; G01V 2210/32

(57) ABSTRACT

A method for constructing a seismic image by attenuation of internal multiples, including: receiving a seismic dataset from a data processing platform; determining a current working swath and a plurality of neighboring swaths in a target swath area to determine a data library for predicting internal multiple events in the target swath area; reducing redundant seismic data in the data library by excluding seismic data outside the target swath area and decimating seismic data based on a predetermined decimation parameter; selecting a raw seismic trace from a seismic source to a seismic receiver; predicting, using a data-driven internal multiple elimination process and the data library, an internal multiple event from the seismic source to the seismic receiver; determining a processed seismic trace by subtracting the internal multiple event from the raw seismic trace; and outputting the processed seismic trace to the data processing platform for imaging a subsurface structure.

### TECHNICAL FIELD

Embodiments of the disclosure generally relate to geophysical exploration using seismic surveying and, more particularly, to reducing data redundancy and improving three-dimensional (3D) data-driven internal multiple elimination for wide azimuth datasets.

### BACKGROUND

A rock formation that resides under the Earth's surface is often called a “subsurface” formation. A subsurface formation containing a subsurface pool of hydrocarbons, such as oil and gas, is usually called a “hydrocarbon reservoir.” Hydrocarbons are typically extracted (or “produced”) from a hydrocarbon reservoir by way of a hydrocarbon well. A hydrocarbon well normally includes a wellbore (or “borehole”) drilled into the reservoir. For example, a hydrocarbon well may include a wellbore that extends into the rock of a reservoir to facilitate the extraction (or “production”) of hydrocarbons from the reservoir, the injection of fluids into the reservoir, or the evaluation and monitoring of the reservoir. Seismic imaging may be used to generate an image of the subsurface for exploration of the hydrocarbon reservoir.

### SUMMARY

The following presents a simplified summary of the disclosed subject matter in order to provide a basic understanding of some aspects of the subject matter disclosed herein. This summary is not an exhaustive overview of the technology disclosed herein. It is not intended to identify key or critical elements of the disclosed subject matter or to delineate the scope of the disclosed subject matter. Its sole purpose is to present some concepts in a simplified form as a prelude to the more detailed description that is discussed later.

A seismic image of the subsurface may be obtained by processing a large amount of seismic data, which includes reflected or refracted energy recorded at the surface in various seismic surveys. For example, the seismic data may be a pressure component of a seismic wave injected into the subsurface by a seismic source, such as an air gun. The seismic wave may include useful signals related to the subsurface structure and unwanted noise, such as internal multiples which reflect multiple times with the subsurface layers. Failure to remove the internal multiples from the acquired seismic data may introduce unwanted artifacts and noise in seismic imaging, leading to inaccurate imaging of geological structures for interpretation.

In one or more embodiments, the present disclosure provides a method for constructing a seismic image by attenuation of internal multiples in a seismic dataset. The method includes receiving the seismic dataset from a wide azimuth seismic survey for imaging a subsurface structure from a data processing platform. The method further includes determining, using the seismic dataset, a plurality of geometry parameters and a current working swath in a target swath area. The method further includes identifying, using the plurality of geometry parameters, a plurality of neighboring swaths in the target swath area. The method further includes determining, using the plurality of neighboring swaths and the current working swath, a data library for predicting internal multiple events in the target swath area. The method further includes reducing, using the plurality of geometry parameters, redundant seismic data in the data library by excluding seismic data outside the target swath area and decimating seismic data based on a predetermined decimation parameter. The method further includes selecting, using the current working swath, a raw seismic trace which originates from a seismic source to a seismic receiver. The method further includes predicting, using a data-driven internal multiple elimination (DDIME) process, a three-dimensional (3D) internal multiple event which originates from the seismic source to the seismic receiver. The method further includes determining a processed seismic trace by subtracting the 3D internal multiple event from the raw seismic trace which originates from the seismic source to the seismic receiver. The method further includes outputting the processed seismic trace to the data processing platform for imaging the subsurface structure.

In one or more embodiments, the present disclosure provides a system for constructing a seismic image by attenuation of internal multiples in a seismic dataset. The system may include a processor and a computer-readable non-transitory storage medium including instructions that, when executed by the processor, cause to the processor to perform operations. The operations include receiving the seismic dataset from a wide azimuth seismic survey for imaging a subsurface structure from a data processing platform. The operations further include determining, using the seismic dataset, a plurality of geometry parameters and a current working swath in a target swath area. The operations further include identifying, using the plurality of geometry parameters, a plurality of neighboring swaths in the target swath area. The operations further include determining, using the plurality of neighboring swaths and the current working swath, a data library for predicting internal multiple events in the target swath area. The operations further include reducing, using the plurality of geometry parameters, redundant seismic data in the data library by excluding seismic data outside the target swath area and decimating seismic data based on a predetermined decimation parameter. The operations further include selecting, using the current working swath, a raw seismic trace which originates from a seismic source to a seismic receiver. The operations further include predicting, using a data-driven internal multiple elimination (DDIME) process, a three-dimensional (3D) internal multiple event which originates from the seismic source to the seismic receiver. The operations further include determining a processed seismic trace by subtracting the 3D internal multiple event from the raw seismic trace which originates from the seismic source to the seismic receiver. The operations further include outputting the processed seismic trace to the data processing platform for imaging the subsurface structure.

In one or more embodiments, the present disclosure provides a non-transitory computer-readable medium having instructions that, when executed by a processor, cause the processor to perform operations. The operations include receiving the seismic dataset from a wide azimuth seismic survey for imaging a subsurface structure from a data processing platform. The operations further include determining, using the seismic dataset, a plurality of geometry parameters and a current working swath in a target swath area. The operations further include identifying, using the plurality of geometry parameters, a plurality of neighboring swaths in the target swath area. The operations further include determining, using the plurality of neighboring swaths and the current working swath, a data library for predicting internal multiple events in the target swath area. The operations further include reducing, using the plurality of geometry parameters, redundant seismic data in the data library by excluding seismic data outside the target swath area and decimating seismic data based on a predetermined decimation parameter. The operations further include selecting, using the current working swath, a raw seismic trace which originates from a seismic source to a seismic receiver. The operations further include predicting, using a data-driven internal multiple elimination (DDIME) process, a three-dimensional (3D) internal multiple event which originates from the seismic source to the seismic receiver. The operations further include determining a processed seismic trace by subtracting the 3D internal multiple event from the raw seismic trace which originates from the seismic source to the seismic receiver. The operations further include outputting the processed seismic trace to the data processing platform for imaging the subsurface structure.

Other aspects and advantages of the claimed subject matter will be apparent from the following description and the appended claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1A illustrates a schematic diagram of a seismic survey in accordance with one or more embodiments.

FIG. 1B illustrates a schematic diagram of an internal multiple attenuation module in accordance with one or more embodiments.

FIG. 2 illustrates a schematic diagram of internal multiple predictions in accordance with one or more embodiments.

FIG. 3 illustrates a shot and receiver distribution for data-driven internal multiple prediction in accordance with one or more embodiments.

FIG. 4 illustrates a spread of receiver lines in a land WAZ survey in accordance with one or more embodiments.

FIG. 5A illustrates a real shot and receiver distribution of a current working swath in accordance with one or more embodiments.

FIG. 5B illustrates a real shot and receiver distribution of a dataset for a working swath in accordance with one or more embodiments.

FIG. 6A illustrates a stacked image of a predicted internal multiple model in accordance with one or more embodiments.

FIG. 6B illustrates a stacked image of a raw input seismic dataset in accordance with one or more embodiments.

FIG. 6C illustrates a stacked image after internal multiple attenuation in accordance with one or more embodiments.

FIG. 7 illustrates a flow chart that shows a process for internal multiple elimination in accordance with one or more embodiments.

FIG. 8 illustrates a functional block diagram of a computer system in accordance with one or more embodiments.

While certain embodiments will be described in connection with the illustrative embodiments shown herein, the subject matter of the present disclosure is not limited to those embodiments. On the contrary, all alternatives, modifications, and equivalents are included within the spirit and scope of the disclosed subject matter as defined by the claims. In the drawings, which are not to scale, the same reference numerals are used throughout the description and in the drawing figures for components and elements having the same structure.

### DETAILED DESCRIPTION

In the following description, for purposes of explanation, numerous specific details are set forth in order to provide a thorough understanding of the inventive concept. In the interest of clarity, not all features of an actual implementation are described. Moreover, the language used in this disclosure has been principally selected for readability and instructional purposes, and may not have been selected to delineate or circumscribe the inventive subject matter, resort to the claims being necessary to determine such inventive subject matter. Reference in this disclosure to “one embodiment” or to “an embodiment” or “another embodiment” means that a particular feature, structure, or characteristic described in connection with the embodiment is included in at least one embodiment of the disclosed subject matter, and multiple references to “one embodiment” or “an embodiment” or “another embodiment” should not be understood as necessarily all referring to the same embodiment.

This disclosure pertains to systems, methods, and computer-readable media for an improved internal multiple attenuation workflow for attenuation of internal multiples for a three-dimensional (3D) wide azimuth dataset. The improved internal multiple attenuation workflow may be implemented by using an optimal data library for data searching and reading multiple seismic traces to determine an internal multiple model. Existing internal multiple attenuation algorithms may predict an internal multiple model based on redundant seismic data and are computationally expensive. However, the optimal data library of the improved internal multiple attenuation workflow of the present disclosure is determined by reducing data redundancy from a plurality of neighboring swaths within a current working swath area. For example, the data library may reduce data redundancy by excluding seismic data traveling outside the current working swath area based on a predetermined criterion. As another example, the optimal data library may reduce data redundancy by decimating the 3D wide azimuth dataset based on a plurality of geometry parameters and a predetermined parameter, such as binning size. Thus, the size of the optimal data library may be significantly reduced by at least a factor of 20 for a typical 3D wide azimuth dataset. Additionally, the optimal data library may be used to predict other types of seismic waves, such as surface-related multiples. Advantageously, the improved internal multiple attenuation workflow may provide an accurate and efficient approach for searching and reading seismic traces to construct the internal multiple model. The approach described in the disclosure may use an interferometry algorithm to generate the internal multiple among real source or receiver locations by integrating cross-correlations or convolutions of wavefields recorded by receivers based on the data library.

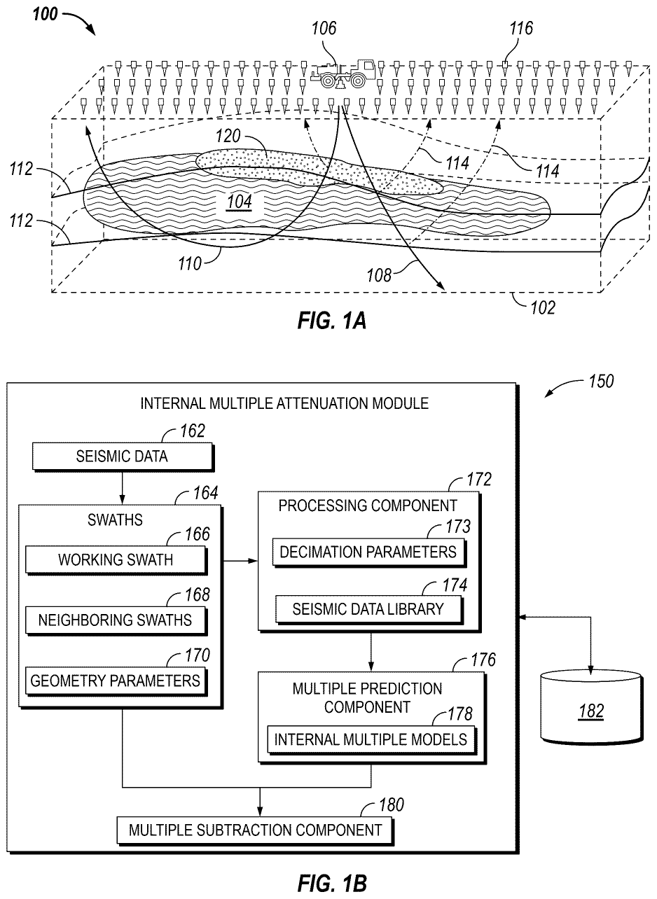

FIG. 1A illustrates a schematic diagram of a seismic survey in accordance with one or more embodiments. FIG. 1A shows a seismic survey 100 of a subterranean region of interest 102, which may contain a reservoir 104. Seismic survey 100 may utilize a seismic source 106, such as a seismic vibrator, which may generate radiated seismic waves 108 to determine an earth response to explore the subsurface structure of the subterranean region of interest 102. For example, radiated seismic waves 108 may propagate into the formations in the earth, such as a gas deposit 120, and return to the surface as refracted seismic waves 110. As another example, radiated seismic waves 108 may be reflected by an interface of subsurface formations, such as geological discontinuities 112, associated with reservoir 104 and return to the surface as reflected seismic waves 114. At the surface, seismic receivers 116 may receive the earth response which includes refracted seismic waves 110 and reflected seismic waves 114, and convert the earth response into representative seismic data (or “seismograms”) using a plurality of electrical, optical, radio, or other sensors.

In some embodiments, the refracted seismic waves 110 and reflected seismic waves 114 generated by a single activation of the seismic source 106 may be recorded by a seismic receiver 116 as a time series representing the amplitude of ground motion at a sequence of discreet times. This time series may be denoted a seismic “trace.” The seismic receivers 116 may be positioned at a plurality of seismic receiver locations which we may denote (xᵣ, yᵣ) where x and y represent orthogonal axes on the earth's surface above the subterranean region of interest 102. Thus, the refracted seismic waves 110 and reflected seismic waves 114 generated by a single activation of seismic source 106 may be represented as a three-dimensional “3D” volume with axes (xᵣ, yᵣ, t) where (xᵣ, yᵣ) represents the location of seismic receiver 116 and t delimits the time sample at which the amplitude of ground motion was measured. In some embodiments, seismic survey 100 may include recordings of seismic waves generated by seismic source 106 positioned at a plurality of seismic source locations (xₛ, yₛ). Thus, the seismic volume for seismic survey 100 may be resented as a five-dimensional volume, denoted (xₛ, yₛ, xᵣ, yᵣ, t).

In some embodiments, seismic survey 100 may be achieved by a wide azimuth (WAZ) seismic acquisition which utilizes multiple energy sources with relatively large and different offsets covering a wide distribution of source-receiver azimuths to accurately image complex subsurface geological structures. Thus, the complex subsurface geological structures may be illuminated from a plurality of different offsets and azimuths for improved imaging performance. For a WAZ seismic acquisition, a large range of short- to long-offset source positions may be used over a large range of source-receiver azimuths for each receiver layout. Compared to a narrow azimuth seismic acquisition, the WAZ seismic acquisition has a relatively large fold distribution with a fold increase determined by the number of reflections from the same reflector. The large fold distribution is desirable because the increase in fold results in a cancellation of the noise in a migration image of the subterranean region of interest 102 due to an improved signal-to-noise ratio. However, such WAZ seismic acquisitions have a large size of seismic data, such as multiple millions of seismic traces, due to the redundancy of the seismic data.

In some embodiments, a 3D land survey is achieved by using a long cross-spread shooting template or a source grid that is much larger than the receiver patch. For example, in a swath shooting configuration, a plurality of receiver cables are laid out in parallel lines in an inline direction. In some embodiments, each receiver cable may include 80 receiver groups at 50-meter (m) spacing. In such embodiments, the spacing between the plurality of receiver cables is 100 m. In the swath, a plurality of shots may be positioned in a perpendicular direction to the inline direction. When the end of the swath is reached, the next swath starts until all of the 3D land survey area is covered.

In some embodiments, a 3D marine survey is achieved by acquiring a plurality of swaths. In each swath, the 3D marine survey has a single-line orientation and a long, narrow spread of streamers in an array towed by a dedicated source vessel for each source. In some embodiments, the towed-streamer array may include a plurality of streamer cables, such as 8 streamer cables in a 1000 m by 8100 m receiver swath, towed at water depths in a range of 5-50 m. Each of the plurality of streamer cables may include hundreds of hydrophones or multi-component sensors which are designed to record the seismic data reflected from subsurface rock formations and other density contrasts. In some embodiments, the seismic source may be activated at predetermined periodic intervals to transmit a seismic wave downward through a water layer and a seabed, where the seismic wave ultimately encounters subsurface rock formations which reflect part of the down-going seismic wave up toward the receivers near the surface.

Primary seismic imaging may provide a seismic processing tool for analyzing a plurality of primary reflections by using both the amplitude and phase information to quantitatively interpret the shape, position, and composition of the subterranean formations. Thus, the primary reflections may be used to map subsurface structures and identify potential oil, gas, or mineral deposits. For example, primary seismic imaging may determine a clear image of the subterranean region of interest 102 by imaging a primary signal, such as the reflected seismic waves 114, in a seismic reflection image. The primary signal may be reflected once by an interface of subsurface formations; thus, the primary signal usually has a relatively strong amplitude which may be properly imaged based on the concept of single scattering. However, the recorded seismic data may also include many unwanted seismic waves, such as internal multiples. Internal multiples are secondary seismic waves reflected multiple times within subsurface layers and often occur in regions with complex overburden and highly reflective shallow geological features. Failure to remove internal multiples from the recorded seismic data may distort the seismic reflection image as artifacts and noises, disrupt the accuracy of primary seismic imaging, and complicate geological interpretation. Thus, internal multiple elimination may be used in seismic processing to achieve a reliable subsurface image for seismic interpretation of reservoir 104.

FIG. 1B illustrates a schematic diagram 150 of an internal multiple attenuation module 160 in accordance with one or more embodiments. Internal multiple attenuation module 160 may implement an internal multiple attenuation workflow using a data-driven internal multiple elimination (DDIME) algorithm to mitigate the internal multiples for a WAZ survey. The internal multiple attenuation workflow may include two steps: (1) determining a plurality of virtual primary events to predict an internal multiple by using convolution and correlation and (2) adaptively subtracting the predicted internal multiple from an original input seismic data. The data-driven internal multiple elimination algorithm relies on traces from multiple shots in a data library determined by using the measured seismic data without any prior information. Thus, the data-driven internal multiple elimination algorithm typically requires data searching and reading complexities which are computationally expensive for a large-scale WAZ survey with a high fold distribution. The size of the data library used for searching and reading may affect the effectiveness of the data-driven internal multiple elimination algorithm. For example, the data library usually has a very large size because of the redundancy of the seismic data. As described herein, the internal multiple attenuation module 160 of the present disclosure provides a reliable mechanism to minimize data redundancy and significantly enhance the efficiency (that is, by reducing the computational resources and time) of the data-driven internal multiple prediction.

In some embodiments, in the first step, internal multiple attenuation module 160 may be configured to receive seismic data 162 for a WAZ survey. For example, the WAZ survey may be acquired from a land acquisition, a marine acquisition, or an ocean bottom acquisition. In some embodiments, internal multiple attenuation module 160 may prepare the acquired seismic data 162 in either shot or receiver order. As another example, internal multiple attenuation module 160 may preprocess seismic data 162 by removing unwanted noises, such as an air bubble noise, an interference noise, a swell noise, a random noise, or other noises. As another example, internal multiple attenuation module 160 may design a common source signature for all the shots in seismic data 162. As another example, internal multiple attenuation module 160 may compensate for the attenuation of seismic data 162 due to a geometric spreading effect.

In some embodiments, internal multiple attenuation module 160 may be configured to determine a plurality of swaths 164 which include a current working swath 166 and a plurality of neighboring swaths 168 based on a plurality of geometry parameters 170 for the WAZ survey. For example, the plurality of geometry parameters 170 include a receiver line interval which is used to identify the plurality of neighboring swaths 168 relative to the current working swath 166. In particular, the plurality of swaths 164 may progress across the survey in a cross-line direction. Internal multiple attenuation module 160 may be configured to identify a plurality of neighboring swaths 168 associated with the current working swath 166. The plurality of neighboring swaths 168 may intersect with the area of the current working swath 166. In some embodiments, the current working swath 166 and the plurality of neighboring swaths 168 may be used to generate a seismic data library 174 which provides an even shot and receiver distribution to determine an internal multiple for the current working swath 166. In some embodiments, the data library 174 may include a large data size due to data redundancy.

Internal multiple attenuation module 160 may include a preprocessing component 172 which is configured to reduce the data size of the data library 174 within the current working swath 166 in accordance with the techniques of the disclosure. In some embodiments, preprocessing component 172 may be configured to remove seismic traces which travel outside the current working swath 166. Furthermore, preprocessing component 172 may be configured to decimate the data library 174 based on a plurality of decimation parameters 173 determined using the plurality of geometry parameters 170. In some embodiments, for example, preprocessing component 172 may be configured to decimate 8 shot lines to 1 shot line at both the top and bottom of each of the plurality of neighboring swaths 168, while seismic data from the current working swath 166 is retained. In other embodiments, a different number of shot lines may be decimated to 1 shot line at both the top and bottom of each of the plurality of neighboring swaths 168. Thus, the data library 174 may significantly reduce data redundancy to speed up the internal multiple prediction process.

In some embodiments, internal multiple attenuation module 160 may include a multiple prediction component 176 which is configured to determine internal multiple models 178 using the data library 174. For example, multiple prediction component 176 may implement a seismic interferometry algorithm to generate internal multiples among real source or receiver locations by integrating cross-correlations or convolutions of wavefields recorded by receivers based on the data library 174. Thus, multiple prediction component 176 may reconstruct an internal multiple model 178 in convolutional and cross-correlational interferometry by combining real or interpolated traces. Additionally, multiple prediction component 176 may be implemented to generate different multiples using seismic interferometry based on the data library 174. For example, multiple prediction component 176 may be implemented to generate a surface-related multiple model by convolving a primary signal with another primary signal.

In some embodiments, internal multiple attenuation module 160 may include a multiple subtraction component 180 which is configured to adaptively remove the determined internal multiple model 176 from the original seismic data (for example, seismic data 162) to achieve internal multiple attenuation. For example, multiple subtraction component 180 may determine a filter stored in a database 182 by matching the determined internal multiple model 178 to an observed internal multiple. Thus, multiple subtraction component 180 may be used by the filter to subtract the determined internal multiple model 178 from the original seismic data (for example, seismic data 162). Furthermore, the internal multiple attenuation module 160 may implement the internal multiple attenuation workflow for other swaths in seismic data 162.

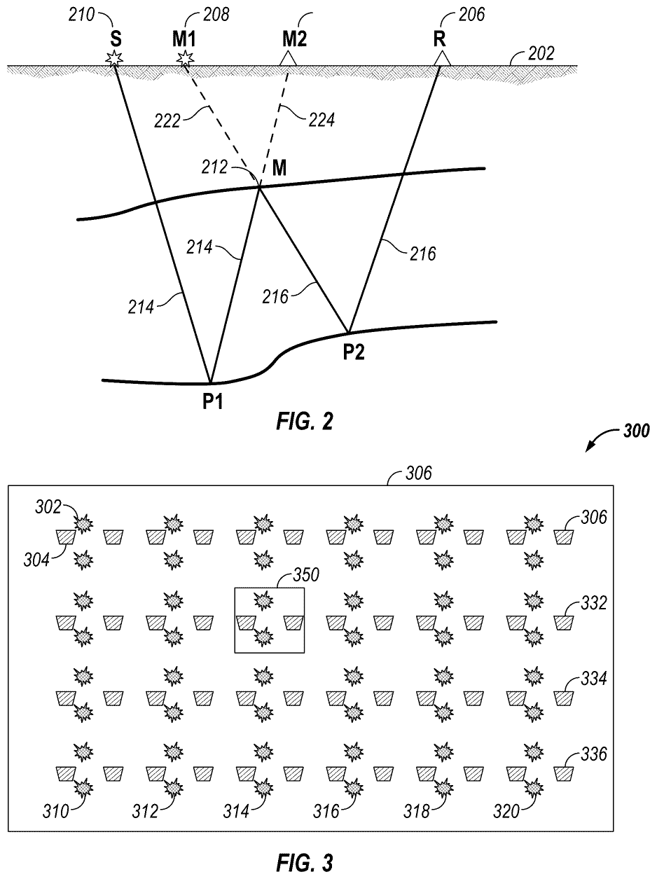

FIG. 2 illustrates a schematic diagram 200 of internal multiple predictions in accordance with one or more embodiments. FIG. 2 shows a seismic source S 204, a seismic receiver R 206, a first virtual point M₁ 208, and a second virtual point M₂ 210 at a surface 202 of the earth. An internal multiple SMR may include a down-going ray path from the seismic source S 204 to a first subsurface reflection point P₁ 218, an up-going ray path from the first subsurface reflection point P₁ 218 to a multiple reflection point M 212, a down-going ray path from the multiple reflection point M 212 to a second subsurface reflection point P₂ 220, and an up-going ray path from the second subsurface reflection point P₂ 220 to the seismic receiver R 206. Thus, the internal multiple SMR may be reconstructed using a plurality of primary reflection traces in two steps. In the first step, an intermediate trace SMM₁ may be generated by correlating a seismic trace SM₂ with a seismic trace M₁M₂. In the second step, the internal multiple SMR may be determined by convolving the intermediate trace SMM₁ with a seismic trace seismic trace M₁R, considering all possible M₁ and M₂ locations. For example, the seismic trace SM₂ includes a ray path SP₁M 214 and a ray path MM₂ 224. As another example, the seismic trace M₁M₂ includes a ray path M₁M 222 and a ray path MM₂ 224. As another example, the seismic trace M₁R includes a ray path M₁M 222 and a ray path MR 216. As another example, the seismic trace SMM₁ includes a ray path SM 214 and a negative ray path MM₁ 222, where, the travel time of seismic trace SMM₁ equals the travel time of ray path SM 214 minus the travel time of ray path MM₁ 222. In practice, the internal multiple SMR may be determined by summing contributions from all possible M₁ and M₂ locations when all source and receiver locations (S, M₁, M₂, and R) are evenly distributed across the working area. Failure to achieve this balance may lead to inaccurate predictions of internal multiples.

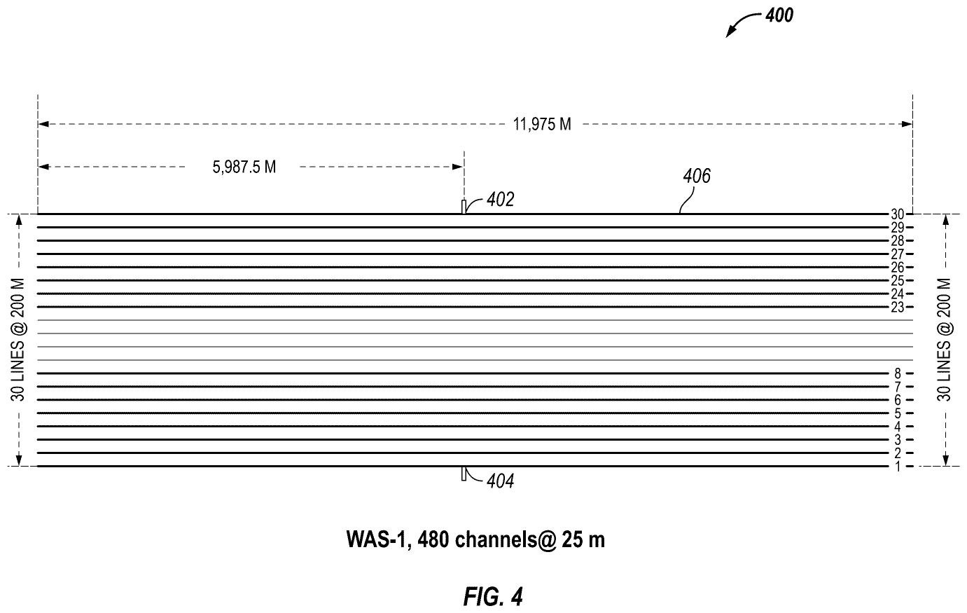

FIG. 3 illustrates a shot and receiver distribution 300 for data-driven internal multiple prediction in accordance with one or more embodiments. The shot and receiver distribution 300 includes a plurality of seismic source lines 310, 312, 314, 316, 318, and 320 and a plurality of seismic receiver lines 330, 332, 334, and 336 for a working area 306 in a land WAZ survey. In the embodiment shown in FIG. 3, each of the plurality of seismic source lines includes eight seismic sources 302, and each of the plurality of seismic receiver lines includes twelve seismic receivers 304. Locations of seismic sources 302 and seismic receivers 304 may be evenly distributed within the working area 306; accordingly, an internal multiple may be accurately reconstructed by summing contributions from all possible virtual points without any missing seismic traces for a particular location within the working area 306. For example, seismic data may be missing for one or more seismic sources or seismic receivers within a localized area 350 possibly due to a local geographic structure, such as a hill, a lake, a house, etc., or malfunction of seismic sources and seismic receivers. As a result, the missing seismic data may cause a problem for the internal multiple predictions by generating unwanted artifacts for a predicted internal multiple for this working area 306. In some embodiments, the missing seismic data may be reconstructed from seismic traces in surrounding areas by using data regularization.

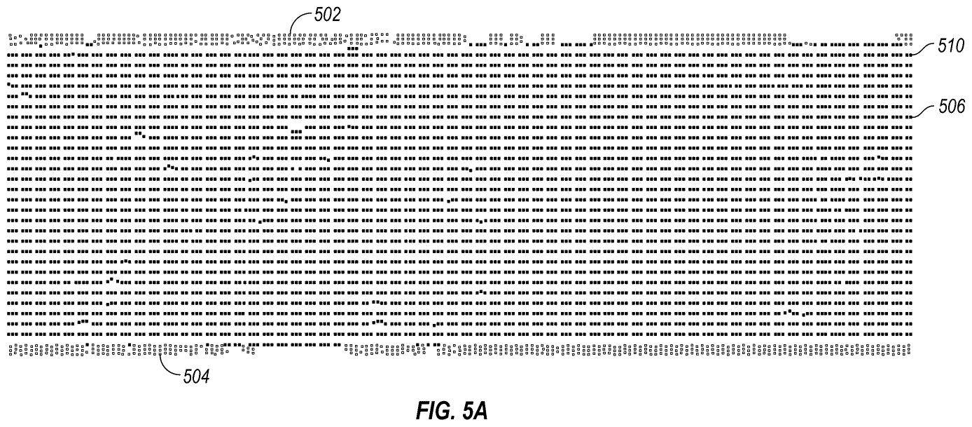

FIG. 4 illustrates a spread of receiver lines 406 in a land WAZ survey 400 in accordance with one or more embodiments. FIG. 4 shows the spread of receiver lines 406 that may be used in the land WAZ survey 400 to record seismic data from eight seismic sources 402 positioned at the middle top and eight seismic sources 404 positioned at the middle bottom with a 25 m interval between any neighboring seismic sources.

In the embodiment depicted in FIG. 4, the spread of receiver lines 406 may include thirty receiver lines along the inline direction with a cross-line interval of 200 m. In this embodiment, each receiver line in the spread may include a plurality of channels, such as 480 channels, along the cross-line direction with an incline interval of 25 m. Thus, the spread of receiver lines 406 covers an area of 5800×11975 m² by using a total of 14400 channels. For the spread of receiver lines 406, the eight seismic sources 402 positioned at the middle top and the eight seismic sources 406 positioned at the middle bottom may be used to achieve wide azimuth with a large channel count to obtain a large illumination and resolution image of subsurface structure. In such embodiments, for each of the seismic sources 204, there may be a large size of seismic traces recorded by all the channels of the spread of receiver lines 406. Thus, such a large size of recorded seismic data becomes a significant burden for internal multiple prediction using prior techniques because of an expensive computation cost.

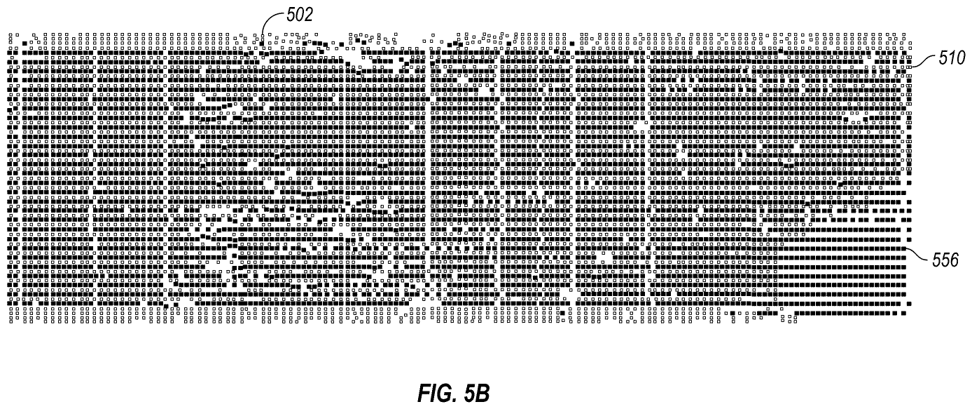

FIG. 5A illustrates a real shot and receiver distribution 500 of a current working swath 510 in accordance with one or more embodiments. FIG. 5A shows a real geometry of the current working swath 510 after inline rolling which includes 30 seismic receiver lines 506 and irregular 16 seismic source lines 502 and 504, configured as 8 seismic source lines 502 at the top and 8 seismic source lines 504 at the bottom. To meet the desired shot and receiver coverage for internal multiple prediction in the current working swath, 60 neighboring swaths after cross-line rolling with 30 swaths on each side may be used for internal multiple prediction. However, the additional 60 neighboring swaths increase the size of seismic data by a factor of 60, which significantly slows down seismic processing time. Furthermore, the seismic data for the 60 neighboring swaths provide data redundancy. In particular, some seismic data may fall outside the current working swath 510, rendering them unnecessary. As described herein, embodiments of the disclosure may mute the seismic data outside the current working swath 510 and decimate the seismic data located in the current working swath 510 from the 60 neighboring swaths to provide an optimal internal multiple attenuation workflow that reduces data size and enhances the efficiency of internal multiple predictions.

FIG. 5B illustrates a real shot and receiver distribution 550 of a dataset for the current working swath 510 of FIG. 5A in accordance with one or more embodiments. FIG. 5B shows the real geometry map after removing data outside the current working swath 510 by decimating 8 seismic source lines to 1 seismic source line at both the top and bottom of each neighboring swath while retaining all seismic source lines from the current working swath 510. As shown in FIG. 5B, all shots 552 and receivers 556 in the real geometry map are evenly distributed. As a result, the embodiments described in the disclosure significantly accelerate the efficiency of internal multiple prediction.

### Application of the Internal Multiple Attenuation Workflow

In some embodiments, the internal multiple attenuation workflow may be applied to a field dataset to remove internal multiples. In particular, the internal multiple attenuation workflow may provide an efficient and accurate method to predict an internal multiple model using an optimized data library. The internal multiple attenuation workflow may adaptively subtract the internal multiple model from the original seismic data to achieve internal multiple attenuation and enable production of an improved seismic image.

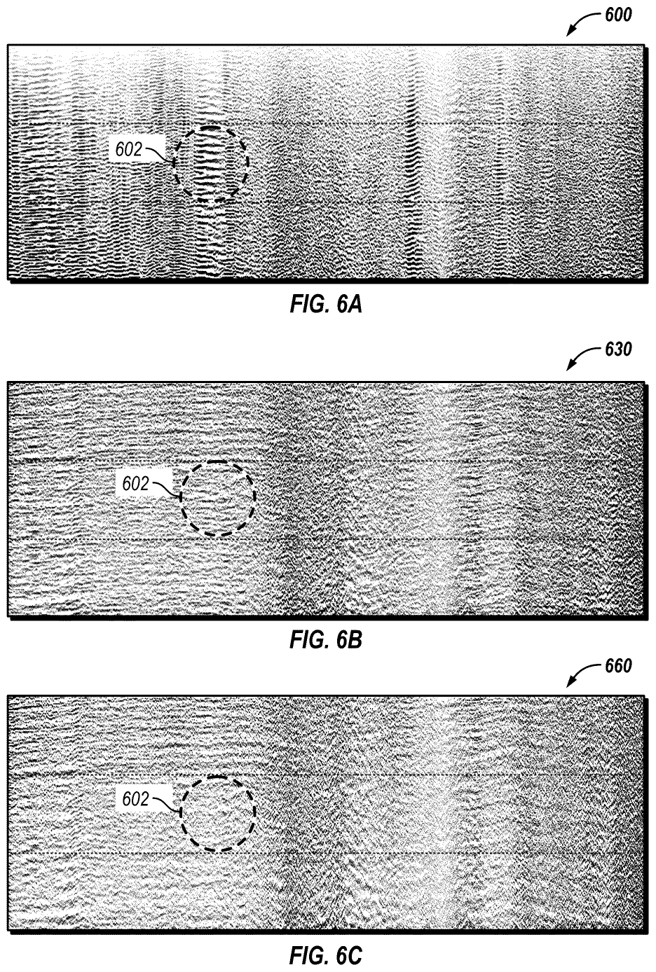

FIG. 6A illustrates a stacked image 600 of a predicted internal multiple model in accordance with one or more embodiments. FIG. 6A shows the stacked image 600 of the predicted internal multiple model having varying internal multiples with complex patterns. For example, the predicted internal multiples in local area 602 have a particularly strong amplitude and lasting feature. FIG. 6B illustrates a stacked image 630 of a raw input seismic dataset in accordance with one or more embodiments. FIG. 6B shows the contamination of the stacked image 630 of the original input seismic data by many internal multiples, such as internal multiple in a local area 602, which interfere with seismic interpretation. Unsuccessful attenuation of these internal multiples may lead to inaccurate interpretation of geological structures, especially in a reservoir. FIG. 6C illustrates a stacked image 660 after internal multiple attenuation of the internal multiples shown in FIG. 6B, in accordance with techniques described in the disclosure. As shown in FIG. 6C, the stacked image 660 has suppressed flat internal multiple events in the local area 602 and is significantly improved as compared to the stack image 630 shown in FIG. 6B after subtracting the predicted internal multiple model from the original seismic data. Furthermore, the performance of the internal multiple attenuation workflow is greatly improved as compared to prior conventional workflows for the attenuation of internal multiple attenuations. By way of example, a performance comparison of the internal multiple attenuation workflow or the present disclosure and a prior conventional internal multiple attenuation workflow is shown in Table 1.

TABLE 1
PERFORMANCE COMPARISON

| | Conventional Workflow | | New Workflow | |
|---|---|---|---|---|
| Data Size of DDIME | 24 | terabytes (T) | 1.2 | T |
| Running Time of DDIME | 1 | month | 13 | hours |

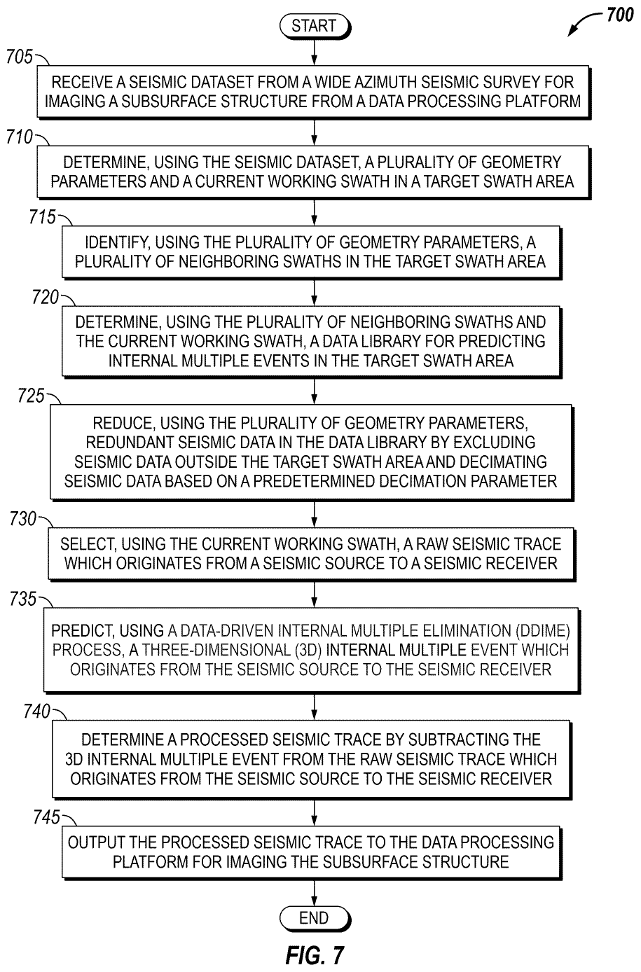

FIG. 7 depicts various elements of a process in accordance with the present techniques. While the various blocks in FIG. 7 are presented and described sequentially, some or all of the blocks may be executed in different orders, may be combined or omitted, and some or all of the blocks may be executed in parallel. Furthermore, the blocks may be performed actively or passively.

FIG. 7 illustrates a flow chart that shows a process 700 for internal multiple elimination in accordance with one or more embodiments. In some embodiments, the process 700 may be implemented to determine an internal multiple model for seismic data acquired in a WAZ survey. At block 705, the process 700 includes receiving a seismic dataset from a wide azimuth seismic survey for imaging a subsurface structure from a data processing platform. For example, the seismic dataset may be acquired from a land seismic data acquisition with a wide distribution of source-receiver azimuths. As another example, the seismic dataset may be acquired from a marine or ocean bottom seismic data acquisition, such as a wide-azimuth towed-streamer acquisition (WATS) or ocean bottom node (OBN) acquisition. The seismic dataset from the wide azimuth seismic survey may be grouped by seismic source. Thus, the seismic dataset may provide improved illumination, greater fold, superior noise, and multiple attenuation, and the possibility for greater resolution with smaller bin sizes compared to a seismic data acquisition with a narrow distribution of source-receiver azimuths.

At block 710, the process 700 includes determining, using the seismic dataset, a plurality of geometry parameters and a current working swath in a target swath area.

At block 715, the process 700 includes identifying, using the plurality of geometry parameters, a plurality of neighboring swaths in the target swath area. In particular, the process 700 may determine the plurality of neighboring swaths to achieve an evenly distributed source-receiver distribution in the target swath area. By way of example, for a WATS survey, an 8 by 8100-meter receiver swath may include eight streamers separated by about 125 meters along the cross-line direction and towed at a depth of 12-15 meters to record multiple shots with a 250-meter overlap in the cross-line direction until the full-fold survey area is covered. Thus, seismic traces from the plurality of neighboring swaths may contribute to the current working swath in the target swath area.

At block 720, the process 700 includes determining, using the plurality of neighboring swaths and the current working swath, a data library for predicting internal multiple events in the target swath area. The data library may include all the seismic traces from the current working swath and the plurality of neighboring swaths. Accordingly, the data library may include a lot of redundant seismic traces in the target swath area.

At block 725, the process 700 includes reducing, using the plurality of geometry parameters, redundant seismic data in the data library by excluding seismic data outside the target swath area and decimating seismic data based on a predetermined decimation parameter. The process 700 may reduce the data size in the data library from the plurality of neighboring swaths within the current working swath. This reduction may involve addressing two forms of redundancy: (1) excluding seismic data outside the current working swath area and (2) decimating seismic traces based on the plurality of geometry parameters and a predetermined decimation parameter for predicting internal multiples. In some embodiments, the process 700 may decimate 8 shot lines to 1 shot line at both the top and bottom of the current working swath area. In other embodiments, a different number of shot lines may be decimated for 1 shot line at both the top and bottom of the current working swatch. All data from the current swath may be retained.

At block 730, the process 700 includes selecting, using the current working swath, a raw seismic trace which originates from a seismic source to a seismic receiver. For example, the process 700 may select a seismic source gather or a seismic receiver gather in which all source and receiver locations are within the current working swath area.

At block 735, the process 700 includes predicting, using a data-driven internal multiple elimination (DDIME) process, a three-dimensional (3D) internal multiple event which originates from the seismic source to the seismic receiver. The DDIME process of block 735 may include determining, using the plurality of geometry parameters, a plurality of first and second multiple position pairs for the 3D internal multiple event. For each of the plurality of first and second multiple position pairs, the process 700 may determine, using the data library, a first seismic trace which originates from the seismic source to a first multiple position, a second seismic trace which originates from the first multiple position to a second multiple position, and a third seismic trace which originates from the second corresponding multiple position to the receiver. The process 700 may then determine an intermediate seismic trace by correlating the first seismic trace with the second seismic trace. Next, the process 700 may determine an internal multiple subset associated with the corresponding first and second multiple position pair by convolving the intermediate seismic trace with the third seismic trace. The process 700 may then determine the 3D internal multiple event by summing the internal multiple subset for the plurality of first and second multiple position pairs. In some embodiments, for each of the plurality of first and second multiple position pairs for the 3D internal multiple event, the process 700 may select the first and second multiple position to be evenly distributed across a working area associated with the raw seismic trace which originates from the seismic source to the seismic receiver. Next, the process 700 may determine the first seismic trace by interpolating a first plurality of seismic traces within a first seismic grid which contains the first seismic trace. Likewise, the process 700 may determine the second seismic trace by interpolating a second plurality of seismic traces within a second seismic grid which contains the second seismic trace. Similarly, the process 700 may determine the third seismic trace by interpolating a third plurality of seismic traces within a third seismic grid which contains the third seismic trace.

At block 740, the process 700 includes determining a processed seismic trace by subtracting the 3D internal multiple event from the raw seismic trace which originates from the seismic source to the seismic receiver. The process 700 may determine a filter by matching the determined the 3D internal multiple event to a corresponding internal multiple event in the raw seismic data. Thus, the process 700 may determine the processed seismic trace by adaptively subtracting the 3D internal multiple event from the raw seismic trace using the filter.

At block 745, the process 700 includes outputting the processed seismic trace to the data processing platform for imaging the subsurface structure. In particular, the process 700 may generate an improved seismic image of the subsurface structure from all the processed seismic traces after internal multiple attenuation.

Particular embodiments may repeat one or more steps of the process of FIG. 7, where appropriate. Although this disclosure describes and illustrates particular steps of the process of FIG. 7 as occurring in a particular order, this disclosure contemplates any suitable steps of the process of FIG. 7 occurring in any suitable order. Moreover, although this disclosure describes and illustrates an example process for attenuation of internal multiples in a seismic dataset, including the particular steps of the process of FIG. 7, this disclosure contemplates any suitable process including any suitable steps, which may include all, some, or none of the steps of the process of FIG. 7, where appropriate. Furthermore, although this disclosure describes and illustrates particular components, devices, or systems carrying out particular steps of the process of FIG. 7, this disclosure contemplates any suitable combination of any suitable components, devices, or systems carrying out any suitable steps of the process of FIG. 7.

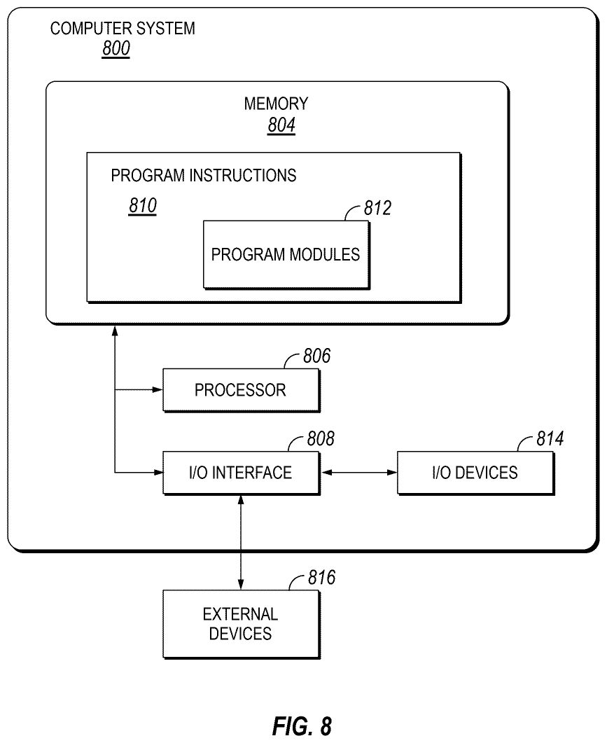

FIG. 8 is a functional block diagram of a computer system (or “system”) 800 in accordance with one or more embodiments. In some embodiments, system 800 is a programmable logic controller (PLC). System 800 may include memory 804, processor 806, and input/output (I/O) interface 808. Memory 804 may include non-volatile memory (for example, flash memory, read-only memory (ROM), programmable read-only memory (PROM), erasable programmable read-only memory (EPROM), electrically erasable programmable read-only memory (EEPROM)), volatile memory (for example, random access memory (RAM), static random access memory (SRAM), synchronous dynamic RAM (SDRAM)), or bulk storage memory (for example, CD-ROM or DVD-ROM, hard drives). Memory 804 may include a non-transitory computer-readable storage medium (for example, non-transitory program storage device) having program instructions 810 stored thereon. Program instructions 810 may include program modules 812 that are executable by a computer processor (for example, processor 806) to cause the functional operations described, such as those described with regard to internal multiple attenuation module 160 or process 700.

Processor 806 may be any suitable processor capable of executing program instructions. Processor 806 may include a central processing unit (CPU) that carries out program instructions (for example, the program instructions of the program modules 812) to perform the arithmetical, logical, or input/output operations described. Processor 806 may include one or more processors. I/O interface 808 may provide an interface for communication with one or more I/O devices 814, such as a joystick, a computer mouse, a keyboard, or a display screen (for example, an electronic display for displaying a graphical user interface (GUI)). I/O devices 814 may include one or more of the user input devices. I/O devices 814 may be connected to I/O interface 808 by way of a wired connection (for example, an Industrial Ethernet connection) or a wireless connection (for example, a Wi-Fi connection). I/O interface 808 may provide an interface for communication with one or more external devices 816. In some embodiments, I/O interface 808 includes one or both of an antenna and a transceiver. In some embodiments, external devices 816 include pre-processing components, multiple prediction components, multiple subtraction components, or other components described in connection with internal multiple attenuation module 160.

Further modifications and alternative embodiments of various aspects of the disclosure will be apparent to those skilled in the art in view of this description. Accordingly, this description is to be construed as illustrative only and is for the purpose of teaching those skilled in the art the general manner of carrying out the embodiments. It is to be understood that the forms of the embodiments shown and described herein are to be taken as examples of embodiments. Elements and materials may be substituted for those illustrated and described herein, parts and processes may be reversed or omitted, and certain features of the embodiments may be utilized independently, all as would be apparent to one skilled in the art after having the benefit of this description of the embodiments. Changes may be made in the elements described herein without departing from the spirit and scope of the embodiments as described in the following claims. Headings used herein are for organizational purposes only and are not meant to be used to limit the scope of the description.

It will be appreciated that the processes and methods described herein are example embodiments of processes and methods that may be employed in accordance with the techniques described herein. The processes and methods may be modified to facilitate variations of their implementation and use. The order of the processes and methods and the operations provided may be changed, and various elements may be added, reordered, combined, omitted, modified, and so forth. Portions of the processes and methods may be implemented in software, hardware, or a combination of software and hardware. Some or all of the portions of the processes and methods may be implemented by one or more of the processors/modules/applications described here.

As used throughout this application, the word “may” is used in a permissive sense (that is, meaning having the potential to), rather than the mandatory sense (that is, meaning must). The words “include,” “including,” and “includes” mean including, but not limited to. As used throughout this application, the singular forms “a,” “an,” and “the” include plural referents unless the content clearly indicates otherwise. Thus, for example, reference to “an element” may include a combination of two or more elements. As used throughout this application, the term “or” is used in an inclusive sense, unless indicated otherwise. That is, a description of an element including A or B may refer to the element including one or both of A and B. As used throughout this application, the phrase “based on” does not limit the associated operation to being solely based on a particular item. Thus, for example, processing “based on” data A may include processing based at least in part on data A and based at least in part on data B, unless the content clearly indicates otherwise. As used throughout this application, the term “from” does not limit the associated operation to being directly from. Thus, for example, receiving an item “from” an entity may include receiving an item directly from the entity or indirectly from the entity (for example, by way of an intermediary entity). Unless specifically stated otherwise, as apparent from the discussion, it is appreciated that throughout this specification discussions utilizing terms such as “processing,” “computing,” “calculating,” “determining,” or the like refer to actions or processes of a specific apparatus, such as a special purpose computer or a similar special purpose electronic processing/computing device. In the context of this specification, a special purpose computer or a similar special purpose electronic processing/computing device is capable of manipulating or transforming signals, typically represented as physical, electronic, or magnetic quantities within memories, registers, or other information storage devices, transmission devices, or display devices of the special purpose computer or similar special purpose electronic processing/computing device.

At least one embodiment is disclosed and variations, combinations, modifications of the embodiment(s), or features of the embodiment(s) made by a person having ordinary skill in the art are within the scope of the disclosure. Alternative embodiments that result from combining, integrating, or omitting features of the embodiment(s) are also within the scope of the disclosure. Where numerical ranges or limitations are expressly stated, such express ranges or limitations may be understood to include iterative ranges or limitations of like magnitude falling within the expressly stated ranges or limitations (for example, from about 1 to about 10 includes, 2, 3, 4, etc.; greater than 0.10 includes 0.11, 0.12, 0.13, etc.). The use of the term “about” (or its variants) means ±10% of the subsequent number, unless otherwise stated.

Use of the term “optionally” with respect to any element of a claim means that the element is required, or alternatively, the element is not required, both alternatives being within the scope of the claim. Use of broader terms such as comprises, includes, and having may be understood to provide support for narrower terms such as consisting of, consisting essentially of, and comprised substantially of. Accordingly, the scope of protection is not limited by the description but is defined by the claims that follow, that scope including all equivalents of the subject matter of the claims. Each and every claim is incorporated as further disclosure into the specification and the claims are embodiment(s) of the present disclosure.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise.

Many other embodiments will be apparent to those of skill in the art upon reviewing the description. The scope of the subject matter of the present disclosure therefore should be determined with reference to the appended claims, along with the full scope of equivalents to which such claims are entitled. In the appended claims, the terms “including” and “in which” are used as the plain-English equivalents of the respective terms “comprising” and “wherein.”

What is claimed is:

1. A method for constructing a seismic image by attenuation of internal multiples in a seismic dataset, comprising:
receiving the seismic dataset from a wide azimuth seismic survey for imaging a subsurface structure from a data processing platform;
determining, using the seismic dataset, a plurality of geometry parameters and a current working swath in a target swath area;
identifying, using the plurality of geometry parameters, a plurality of neighboring swaths in the target swath area;
determining, using the plurality of neighboring swaths and the current working swath, a data library for predicting internal multiple events in the target swath area;
reducing, using the plurality of geometry parameters, redundant seismic data in the data library by excluding seismic data outside the target swath area and decimating seismic data based on a predetermined decimation parameter;
selecting, using the current working swath, a raw seismic trace which originates from a seismic source to a seismic receiver;
predicting, using a data-driven internal multiple elimination (DDIME) process, a three-dimensional (3D) internal multiple event which originates from the seismic source to the seismic receiver;
determining a processed seismic trace by subtracting the 3D internal multiple event from the raw seismic trace which originates from the seismic source to the seismic receiver; and
outputting the processed seismic trace to the data processing platform for imaging the subsurface structure.

2. The method of claim 1, wherein the seismic dataset from the wide azimuth seismic survey is grouped by seismic source.

3. The method of claim 1, further comprising:
reducing, using the plurality of geometry parameters, redundant seismic data in the data library by decimating source lines in the plurality of neighboring swaths at a predetermined factor.

4. The method of claim 1, further comprising:
retaining sources from the current working swath in the data library.

5. The method of claim 1, further comprising:
generating a seismic image of the subsurface structure from the processed seismic trace.

6. The method of claim 1, wherein the DDIME process comprises:
determining, using the plurality of geometry parameters, a plurality of first and second multiple position pairs for the 3D internal multiple event;
for each of the plurality of first and second multiple position pairs:
determining, using the data library, a first seismic trace which originates from the seismic source to a first multiple position, a second seismic trace which originates from the first multiple position to a second multiple position, and a third seismic trace which originates from the second corresponding multiple position to the receiver;
determining an intermediate seismic trace by correlating the first seismic trace with the second seismic trace; and
determining an internal multiple subset associated with the corresponding first and second multiple position pair by convolving the intermediate seismic trace with the third seismic trace; and
determining the 3D internal multiple event by summing the internal multiple subset for the plurality of first and second multiple position pairs.

7. The method of claim 6, wherein the DDIME process further comprises:
for each of the plurality of first and second multiple position pairs for the 3D internal multiple event, selecting the first and second multiple position to be evenly distributed across a working area associated with the raw seismic trace which originates from the seismic source to the seismic receiver.

8. The method of claim 6, wherein the DDIME process further comprises:
achieving an even distribution of the seismic source, the first multiple position, the second multiple position, and the seismic receiver in the working area.

9. The method of claim 6, wherein the DDIME process further comprises:
determining the first seismic trace by interpolating a first plurality of seismic traces within a first seismic grid which contains the first seismic trace.

10. The method of claim 6, wherein the DDIME process further comprises:
determining the second seismic trace by interpolating a second plurality of seismic traces within a second seismic grid which contains the second seismic trace.

11. The method of claim 6, wherein the DDIME process further comprises:
determining the third seismic trace by interpolating a third plurality of seismic traces within a third seismic grid which contains the third seismic trace.

12. A system for constructing a seismic image by attenuation of internal multiples in a seismic dataset, comprising:
a processor; and
a computer-readable non-transitory storage medium comprising instructions that, when executed by the processor, cause the processor to perform operations comprising:
receiving the seismic dataset from a wide azimuth seismic survey for imaging a subsurface structure from a data processing platform;
determining, using the seismic dataset, a plurality of geometry parameters and a current working swath in a target swath area;
identifying, using the plurality of geometry parameters, a plurality of neighboring swaths in the target swath area;
determining, using the plurality of neighboring swaths and the current working swath, a data library for predicting internal multiple events in the target swath area;
reducing, using the plurality of geometry parameters, redundant seismic data in the data library by excluding seismic data outside the target swath area and decimating seismic data based on a predetermined decimation parameter;
selecting, using the current working swath, a raw seismic trace which originates from a seismic source to a seismic receiver;
predicting, using a data-driven internal multiple elimination (DDIME) process, a three-dimensional (3D) internal multiple event which originates from the seismic source to the seismic receiver;
determining a processed seismic trace by subtracting the 3D internal multiple event from the raw seismic trace which originates from the seismic source to the seismic receiver; and
outputting the processed seismic trace to the data processing platform for imaging the subsurface structure.

13. The system of claim 12, wherein the seismic dataset from the wide azimuth seismic survey is grouped by seismic source.

14. The system of claim 12, the operations further comprising:
reducing, using the plurality of geometry parameters, redundant seismic data in the data library by decimating source lines in the plurality of neighboring swaths at a predetermined factor.

15. The system of claim 12, the operations further comprising:
retaining sources from the current working swath in the data library.

16. The system of claim 12, the operations further comprising:
generating a seismic image of the subsurface structure from the processed seismic trace.

17. The system of claim 12, wherein the DDIME process comprises:
determining, using the plurality of geometry parameters, a plurality of first and second multiple position pairs for the 3D internal multiple event;
for each of the plurality of first and second multiple position pairs:
determining, using the data library, a first seismic trace which originates from the seismic source to a first multiple position, a second seismic trace which originates from the first multiple position to a second multiple position, and a third seismic trace which originates from the second corresponding multiple position to the receiver;
determining an intermediate seismic trace by correlating the first seismic trace with the second seismic trace; and
determining an internal multiple subset associated with the corresponding first and second multiple position pair by convolving the intermediate seismic trace with the third seismic trace; and
determining the 3D internal multiple event by summing the internal multiple subset for the plurality of first and second multiple position pairs.

18. The system of claim 17, wherein the DDIME process further comprises:
for each of the plurality of first and second multiple position pairs for the 3D internal multiple event, selecting the first and second multiple position to be evenly distributed across a working area associated with the raw seismic trace which originates from the seismic source to the seismic receiver.

19. The system of claim 17, wherein the DDIME process further comprises:
determining the first seismic trace by interpolating a first plurality of seismic traces within a first seismic grid which contains the first seismic trace;
determining the second seismic trace by interpolating a second plurality of seismic traces within a second seismic grid which contains the second seismic trace;
determining the third seismic trace by interpolating a third plurality of seismic traces within a third seismic grid which contains the third seismic trace; and
achieving an even distribution of the seismic source, the first multiple position, the second multiple position, and the seismic receiver in the working area.

20. A non-transitory computer-readable medium comprising instructions that are configured, when executed by a processor, to perform operations comprising:
receiving a seismic dataset from a wide azimuth seismic survey for imaging a subsurface structure from a data processing platform;
determining, using the seismic dataset, a plurality of geometry parameters and a current working swath in a target swath area;
identifying, using the plurality of geometry parameters, a plurality of neighboring swaths in the target swath area;
determining, using the plurality of neighboring swaths and the current working swath, a data library for predicting internal multiple events in the target swath area;
reducing, using the plurality of geometry parameters, redundant seismic data in the data library by excluding seismic data outside the target swath area and decimating seismic data based on a predetermined decimation parameter;
selecting, using the current working swath, a raw seismic trace which originates from a seismic source to a seismic receiver;
predicting, using a data-driven internal multiple elimination (DDIME) process, a three-dimensional (3D) internal multiple event which originates from the seismic source to the seismic receiver;
determining a processed seismic trace by subtracting the 3D internal multiple event from the raw seismic trace which originates from the seismic source to the seismic receiver; and
outputting the processed seismic trace to the data processing platform for imaging the subsurface structure.
